(19) United States
(12) Patent Application Publication
(10) Pub. No.: US 2025/0340460 A1
(43) Pub. Date: Nov. 6, 2025

(54) METAL OXIDE MODIFIED ZEOLITIC IMIDAZOLATE FRAMEWORK-8 FOR WATER TREATMENT

(71) Applicant: KING FAHD UNIVERSITY OF PETROLEUM AND MINERALS, Dhahran (SA)

(72) Inventor: Sagheer A. ONAIZI, Dhahran (SA)

(73) Assignee: KING FAHD UNIVERSITY OF PETROLEUM AND MINERALS, Dhahran (SA)

(21) Appl. No.: 18/654,608

(22) Filed: May 3, 2024

(51) Int. Cl. C02F 1/28; B01J 20/08; B01J 20/22; B01J 20/28; B01J 20/30; B01J 20/32; C02F 101/30

(52) U.S. Cl. CPC C02F 1/288; B01J 20/08; B01J 20/226; B01J 20/28059; B01J 20/28061; B01J 20/28064; B01J 20/28071; B01J 20/28083; B01J 20/3078; B01J 20/3085; B01J 20/3206; B01J 20/3214; B01J 20/3236; B01J 20/3293; C02F 1/281; C02F 1/285; C02F 2101/308; C02F 2303/16

(57) ABSTRACT

A water treatment method includes contacting a contaminated aqueous composition containing one or more anionic azo dyes with an adsorbent to adsorb the one or more anionic azo dyes on surfaces and pores of the adsorbent and form a purified aqueous composition. The adsorbent is at least one of a zeolitic imidazolate framework-8 modified MnCuAl layered triple hydroxide (ZIF-8@MnCuAl-LTH), a MnCuAl layered triple hydroxide modified zeolitic imidazolate framework-8 (MnCuAl-LTH@ZIF-8), and a MnCuAl layered triple oxide modified zeolitic imidazolate framework-8 (MnCuAl-LTO@ZIF-8). The adsorbent has an adsorption capacity in a range of 50 to 700 milligrams the one or more anionic azo dyes per gram of the adsorbent (mg/g) in the contaminated aqueous composition having a pH of 4 to 12.

### BACKGROUND

### Technical Field

The present disclosure is directed to a water treatment method and an adsorbent, and more particularly, directed to a zeolitic imidazolate framework-8 modified with metal oxides for water treatment.

### Description of the Related Prior Art

The description of the related prior art provided herein is for the purpose of generally presenting the context of the disclosure. Work of the presently named inventors, to the extent described in this background section, as well as aspects of the description which may not otherwise qualify as prior art at the time of filing, are neither expressly nor impliedly admitted as prior art against the present invention.

Textile industry is recognized as a major contributor to water pollution in rivers, primarily due to the release of dyes into aquatic environments. Commonly used dyes such as Congo red (CR), reactive black 5 (RB5), and acid red are known to be particularly problematic. Those dye molecules often carry negative charges when dissociated in water, classifying them as anionic dyes. When these dyes are discharged directly into surface waters, they impede the penetration of sunlight, essential for the photosynthesis of aquatic plants. Additionally, they present health hazards to both the aquatic ecosystem and the human population living in proximity to affected rivers. Therefore, proper treatment of textile wastewater is imperative to safeguard the environment and preserve the delicate balance of aquatic ecosystems (See: Syieluing Wong, et. al., Effective removal of anionic textile dyes using adsorbent synthesized from coffee waste, Scientific Reports volume 10, Article number: 2928 (2020)).

Methods have been developed to remove these dyes from water, such as adsorption, coagulation-flocculation, ultrasound irradiation, ion-exchange, mineralization, and photocatalysis. Among these methods, adsorption is a widely used method, due to its advantages such as low cost, large quantities of available adsorbents, ease of operation, high adsorption capacity, easy regeneration potential, and minimum energy requirement. Examples of commonly used adsorbents in the water treatment process include activated carbon, clay, silica gel, peat, graphene oxide (GO) based materials, agricultural waste, and industrial waste such as fly ash. However, these adsorbents come with inherent limitations such as challenges in large-scale application and poor selectivity. Therefore, there is a need to develop an effective and efficient method for removing dyes from wastewater in a cost-effective and straightforward manner.

Accordingly, it is one objective of the present disclosure to provide a water treatment method in the presence of an adsorbent. A second objective of the present disclosure is to provide a method for regenerating the adsorbent. A third objective of the present disclosure is to provide methods of making the adsorbent SUMMARY In an exemplary embodiment, a water treatment method is disclosed. The water treatment method includes contacting a contaminated aqueous composition containing one or more anionic azo dyes with an adsorbent to adsorb the one or more anionic azo dyes on surfaces and pores of the adsorbent and form a purified aqueous composition. In some embodiments, the adsorbent is at least one of a zeolitic imidazolate framework-8 modified MnCuAl layered triple hydroxide (ZIF-8@MnCuAl-LTH), a MnCuAl layered triple hydroxide modified zeolitic imidazolate framework-8 (MnCuAl-LTH@ZIF-8), and a MnCuAl layered triple oxide modified zeolitic imidazolate framework-8 (MnCuAl-LTO@ZIF-8). In some embodiments, the adsorbent has an adsorption capacity in a range of 50 to 700 milligrams (mg) the one or more anionic azo dyes per gram of the adsorbent (mg/g) in the contaminated aqueous composition having a pH of 4 to 12.

In some embodiments, the one or more anionic azo dyes are selected from the group consisting of acid red 1 (AR1), congo red, orange II, acid orange 7, acid red 73, acid yellow 36, acid blue 9, and acid black 1.

In some embodiments, the one or more anionic azo dyes are present in the contaminated aqueous composition in an amount of 10 to 1000 parts per million (ppm) based on a total weight of the contaminated aqueous composition.

In some embodiments, the adsorbent is a ZIF-8@MnCuAl-LTH, and the method has an adsorption capacity of about 600 to 700 milligrams per gram (mg/g) at a pH of about 8.

In some embodiments, the adsorbent is a ZIF-8 @MnCuAl-LTH with a Brunauer-Emmett-Teller (BET) surface area of 40 to 50 square meters per gram (m²/g). In some embodiments, the ZIF-8@MnCuAl-LTH has a cumulative pore volume of 0.2 to 0.25 cubic centimeters per gram (cm³/g). In some embodiments, the ZIF-8@MnCuAl-LTH has an average pore diameter of 15 to 20 nanometers (nm).

In some embodiments, the adsorbent is a MnCuAl-LTH@ZIF-8 with a BET surface area of 630 to 650 m²/g. In some embodiments, the MnCuAl-LTH@ZIF-8 has a cumulative pore volume of 0.1 to 0.15 cm³/g. In some embodiments, the MnCuAl-LTH@ZIF-8 has an average pore diameter of 25 to 30 nm.

In some embodiments, the adsorbent is a MnCuAl-LTO@ZIF-8 with a BET surface area of 480 to 500 m²/g. In some embodiments, the MnCuAl-LTO@ZIF-8 has a cumulative pore volume of 0.05 to 0.1 cm³/g. In some embodiments, the MnCuAl-LTO@ZIF-8 has an average pore diameter of 28 to 32 nm.

In some embodiments, the method further includes regenerating the adsorbent by separating the adsorbent containing the one or more anionic azo dyes after the contacting from the purified aqueous composition and washing with two or more aqueous liquids to form a regenerated adsorbent. In some embodiments, the regenerated adsorbent has a dye removal rate of at least 70% based on an initial concentration of the one or more anionic azo dyes present in the contaminated aqueous composition.

In some embodiments, the two or more aqueous liquids are selected from the group consisting of water, methanol, ethanol, propanol, butanol, pentanol, hexanol, and isomers and mixtures thereof.

In some embodiments, the adsorbent is a ZIF-8@MnCuAl-LTH.

In an exemplary embodiment, a method of preparing the ZIF-8@MnCuAl-LTH is described. The method includes dispersing zeolitic imidazolate framework-8 (ZIF-8) in the form of particles in an alkaline solution to form a first dispersion. The method further includes mixing a manganese salt, a copper salt, and an aluminum salt in water to form an aqueous salt solution. Furthermore, the method includes simultaneously dropwise adding and mixing the aqueous salt solution, and the alkaline solution to the first dispersion to form a reaction mixture and heating the reaction mixture at a temperature of 70 to 150 degrees Celsius (° C.).

In some embodiments, the alkaline solution comprises two or more inorganic salts selected from the group consisting of sodium carbonate, sodium bicarbonate, sodium hydroxide, potassium carbonate, potassium bicarbonate, and potassium hydroxide.

In some embodiments, a molar ratio of the manganese salt to the copper salt is in a range of 1:5 to 5:1, and wherein a molar ratio of the manganese salt to the aluminum salt is in a range of 1:5 to 5:1.

In some embodiments, the adsorbent is a MnCuAl-LTH@ZIF-8.

In an exemplary embodiment, a method of preparing the MnCuAl-LTH@ZIF-8 is described. The method includes mixing a manganese salt, a copper salt, and an aluminum salt in water to form an aqueous salt solution. Then, mixing the aqueous salt solution and an alkaline solution to form a reaction mixture, heating, and drying to form a MnCuAl layered triple hydroxide modified zeolitic composite (MnCuAl-LTH) in the form of particles. The method further includes dispersing particles of the MnCuAl-LTH in water to form a dispersion. Furthermore, the method includes mixing a zinc salt aqueous solution, an imidazole solution, and the dispersion thereby reacting to form the MnCuAl-LTH@ZIF-8.

In some embodiments, the method further includes preparing a MnCuAl layered triple oxide modified zeolitic composite (MnCuAl-LTO) by calcining the MnCuAl-LTH at a temperature of about 400 to 600° C.

These and other aspects of non-limiting embodiments of the present disclosure will become apparent to those skilled in the art upon review of the following description of specific non-limiting embodiments of the disclosure in conjunction with the accompanying drawings.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart describing a method of preparing a zeolitic imidazolate framework-8 modified MnCuAl layered triple hydroxide (referred to as ZIF-8@MnCuAl-LTH) composite, according to certain embodiments;

FIG. 1B is a flowchart describing a method of preparing a MnCuAl layered triple hydroxide modified zeolitic imidazolate framework-8 (referred to as MnCuAl-LTH@ZIF-8) composite, according to certain embodiments;

FIG. 1C is a flowchart describing a method of water treatment, according to certain embodiments;

FIG. 2 shows X-ray diffractogram (XRD) diffraction patterns of various composites and their parental materials, according to certain embodiments;

FIG. 3A shows N₂ adsorption/desorption isotherms of zeolitic imidazolte framework-8 (ZIF-8), according to certain embodiments;

FIG. 3B shows N₂ adsorption/desorption isotherms of a MnCuAl layered triple hydroxide (MnCuAl-LTH), according to certain embodiments;

FIG. 3C shows N₂ adsorption/desorption isotherms of a MnCuAl layered triple oxide (MnCuAl-LTO), according to certain embodiments;

FIG. 3D shows N₂ adsorption/desorption isotherms of the ZIF-8@MnCuAl-LTH composite, according to certain embodiments;

FIG. 3E shows N₂ adsorption/desorption isotherms of the MnCuAl-LTH@ZIF-8 composite, according to certain embodiments;

FIG. 3F shows N₂ adsorption/desorption isotherms of a MnCuAl layered triple oxide modified zeolitic imidazolate framework-8 (MnCuAl-LTO@ZIF-8) composite, according to certain embodiments;

FIG. 4A shows a Fourier Transform Infrared (FTIR) spectra of MnCuAl-LTH, according to certain embodiments;

FIG. 4B shows an FTIR spectra of MnCuAl-LTO, according to certain embodiments;

FIG. 4C shows an FTIR spectra of ZIF-8, according to certain embodiments;

FIG. 4D shows an FTIR spectra of the ZIF-8@MnCuAl-LTH composite, according to certain embodiments;

FIG. 4E shows an FTIR spectra of the MnCuAl-LTH@ZIF-8 composite, according to certain embodiments;

FIG. 4F shows an FTIR of the MnCuAl-LTO@ZIF-8 composite, according to certain embodiments;

FIG. 5 is a diagram showing adsorption of acid red dye (AR1) onto various composites and their parental materials, according to certain embodiments;

FIG. 6 is a plotted graph showing zeta potential analysis for the determination of the point of zero charge (pH_{PZC}) for various composites and their parental materials, according to certain embodiments;

FIG. 7 is a plotted graph showing effect of pH on the adsorption of AR1 onto the ZIF-8@MnCuAl-LTH composite, according to certain embodiments; and

FIG. 8 is a diagram showing reusability of the ZIF-8@MnCuAl-LTH composite, according to certain embodiments.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claim.

The terminologies and/or phrases used herein is for the purpose of describing embodiments only and is not intended to be limiting of the invention. As used herein, the singular forms “a,” “an,” and “the” are intended to include the plural forms as well, unless the context clearly indicates otherwise.

Unless defined otherwise, all technical and scientific terms used herein have the same meaning as is commonly understood by one of ordinary skill in the art. For clarity, the following specific terms have the specified meanings. Other terms are defined in other sections herein.

In the drawings, like reference numerals designate identical or corresponding parts throughout the several views. Further, as used herein, the words “a,” “an” and the like generally carry a meaning of “one or more,” unless stated otherwise.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

The use of the terms “include,” “includes”, “including,” “have,” “has,” or “having” should be generally understood as open-ended and non-limiting unless specifically stated otherwise.

Aspects of the present disclosure are directed to a zeolitic imidazolate framework-8 (ZIF-8) modified with MnCuAl layered triple hydroxide (LTH) or MnCuAl-layered triple oxide (LTO) for use as adsorbents for water decontamination.

According to a first aspect of the present disclosure, an adsorbent is described. The adsorbent is a zeolite-based material, indicating that it includes at least one zeolitic material and one or more metal oxides. As used herein, the term “zeolitic material”, “zeolitic framework” or “zeolitic imidazole framework” refers to a material having the crystalline structure or three-dimensional framework of, but not necessarily the elemental composition of, a zeolite. Zeolites are porous silicate or aluminosilicate minerals that occur in nature. Elementary building units of zeolites are SiO₄ (and if appropriate, AlO₄) tetrahedra. Adjacent tetrahedra are linked at their corners via a common oxygen atom, which results in an inorganic macromolecule with a three-dimensional framework (frequently referred to as the zeolite framework). The three-dimensional framework of a zeolite also includes channels, channel intersections, and/or cages having dimensions in the range of 0.1-10 nanometers (nm), preferably 0.2-5 nm, more preferably 0.2-2 nm. Other ranges are also possible. Water molecules may be present inside these channels, channel intersections, and/or cages. Zeolites that are devoid of aluminum may be referred to as “all-silica zeolites” or “aluminum-free zeolites.” In some embodiments, some zeolites which are substantially free of, but not devoid of, aluminum is referred to as “high-silica zeolites”. In some embodiments, the term “zeolite” is used to refer exclusively to aluminosilicate materials, excluding aluminum-free zeolites or all-silica zeolites.

In some embodiments, the zeolitic material has a three-dimensional framework that is at least one zeolite framework selected from the group consisting of a 4-membered ring zeolite framework, a 6-membered ring zeolite framework, a 10-membered ring zeolite framework, and a 12-membered ring zeolite framework. The zeolite may have a natrolite framework (e.g. gonnardite, natrolite, mesolite, paranatrolite, scolecite, and tetranatrolite), edingtonite framework (e.g. edingtonite and kalborsite), thomsonite framework, analcime framework (e.g. analcime, leucite, poliucite, and wairakite), phillipsite framework (e.g. harrnotomne), gismnondine framework (e.g. amicite, gismondine, garronite, and gobbinsite), chabazite framework (e.g. chabazite-series, herschelite, willhendersonite, and SSZ-13), faujasite framework (e.g. faujasite-series, Linde type X, and Linde type Y), mordenite framework (e.g. maricopaite and mordenite), heulandite framework (e.g. clinoptilolite and heulandite-series), stilbite framework (e.g. barrerite, stellerite, and stilbite-series), brewsterite framework, or cowlesite framework.

The zeolitic material in the present disclosure is zeolitic imidazolate framework (ZIF)-8. In some embodiments, the ZIF-8 material may be used in combination with ZIF-1, ZIF-2, ZIF-3, ZIF-4, ZIF-5, ZIF-6, ZIF-7, ZIF-9, ZIF-10, ZIF-11, ZIF-12, ZIF-14, ZIF-20, ZIF-21, ZIF-22, ZIF-23, ZIF-25, ZIF-60, ZIF-61, ZIF-62, ZIF-63, ZIF-64, ZIF-65, ZIF-66, ZIF-68, ZIF-69, ZIF-70, ZIF-71, ZIF-72, ZIF-73, ZIF-74, ZIF-75, ZIF-76, ZIF-77, ZIF-78, ZIF-79, ZIF-80, ZIF-81, ZIF-82, ZIF-90, ZIF-91, ZIF-92, ZIF-93, ZIF-94, ZIF-96, ZIF-97, ZIF-100, ZIF-108, ZIF-303, ZIF-360, ZIF-365, ZIF-376, ZIF-386, ZIF-408, ZIF-410, ZIF-412, ZIF-413, ZIF-414, ZIF-486, ZIF-516, ZIF-586, ZIF-615, and ZIF-725. The ZIF-8 is crystalline in nature.

In some embodiments, the ZIF-8 may be modified with the metal oxides of at least one metal selected from the group consisting of manganese (Mn), copper (Cu), aluminum (Al), or mixtures thereof. In some embodiments, the metal oxide is MnCuAl-layered triple oxide (MnCuAl-LTO). In some embodiments, the ZIF-8 may be modified with the metal hydroxides of at least one metal selected from the group consisting of manganese (Mn), copper (Cu), aluminum (Al), or mixtures thereof. In an embodiment, the metal oxide is MnCuAl-layered tripled hydroxide (MnCuAl-LTH). In some embodiments, the metal oxide and metal hydroxide may be amorphous or crystalline in nature. In some embodiments, the metal oxide and metal hydroxide include mesopores or macropores.

In some embodiments, the adsorbent is at least one of a zeolitic imidazolate framework-8 modified MnCuAl layered triple hydroxide (ZIF-8@MnCuAl-LTH), a MnCuAl layered triple hydroxide modified zeolitic imidazolate framework-8 (MnCuAl-LTH@ZIF-8), and a MnCuAl layered triple oxide modified zeolitic imidazolate framework-8 (MnCuAl-LTO@ZIF-8). In a preferred embodiment, the adsorbent is the ZIF-8 @MnCuAl-LTH. The ZIF-8@MnCuAl-LTH is mesoporous with an average pore diameter of 15-20 nanometres (nm), preferably 16-19 nm, preferably 17-18 nm, and yet more preferably about 17.6 nm. Other ranges are also possible. In some embodiments, the ZIF-8 @MnCuAl-LTH has a cumulative pore volume of 0.2 to 0.25 cubic centimeters per gram (cm³/g), preferably 0.21-0.24 cm³/g, preferably about 0.236 cm³/g. Other ranges are also possible. In some embodiments, the ZIF-8@MnCuAl-LTH has a Brunauer-Emmett-Teller (BET) surface area of 40 to 50 square meters per gram (m²/g), preferably 41-49 m²/g, preferably 42-48 m²/g, preferably 43-47 m²/g, preferably 44-46 m²/g, preferably 45-46 m²/g, preferably 45.8 m²/g. Other ranges are also possible.

In some embodiments, the adsorbent is the MnCuAl-LTH@ZIF-8. In some embodiments, the MnCuAl-LTH@ZIF-8 has a BET surface area of 630 to 650 m²/g, preferably 632-648 m²/g, preferably 634-646 m²/g, preferably 636-644 m²/g, preferably 638-642 m²/g, more preferably 639-640 m²/g, and yet more preferably 639.1 m²/g. Other ranges are also possible. In some embodiments, the MnCuAl-LTH@ZIF-8 has a cumulative pore volume of 0.1 to 0.15 cm³/g, preferably 0.11-0.14 cm³/g, more preferably 0.12-0.13 cm³/g, and yet more preferably 0.125 cm³/g. Other ranges are also possible. In some embodiments, the MnCuAl-LTH@ZIF-8 has an average pore diameter of 25 to 30 nm, preferably 26-29 nm, preferably 27-28.5 nm, more preferably 28-28.5 nm, and yet more preferably of about 28.3 nm. Other ranges are also possible.

In some embodiments, the adsorbent is the MnCuAl-LTO@ZIF-8. In some embodiments, the MnCuAl-LTO@ZIF-8 has a BET surface area of 450-520 m²/g, preferably 460-510 m²/g, preferably 470-500 m²/g, preferably 480-495 m²/g, preferably 485-491 m²/g, preferably about 490.5 m²/g. Other ranges are also possible. In some embodiments, the MnCuAl-LTO@ZIF-8 has a cumulative pore volume of 0.01 to 0.1 cm³/g, preferably 0.02-0.09 cm³/g, more preferably 0.03-0.082 cm³/g, and yet more preferably 0.082 cm³/g. Other ranges are also possible. In some embodiments, the MnCuAl-LTO@ZIF-8 has an average pore diameter of 28 to 32 nm, preferably 29-31 nm, more preferably 30-31 nm, and yet more preferably 30.4 nm. Other ranges are also possible.

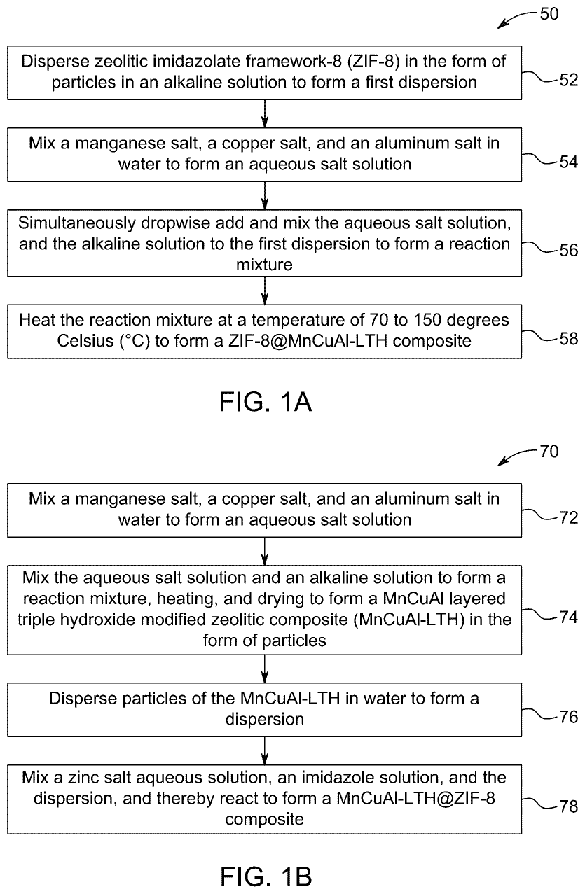

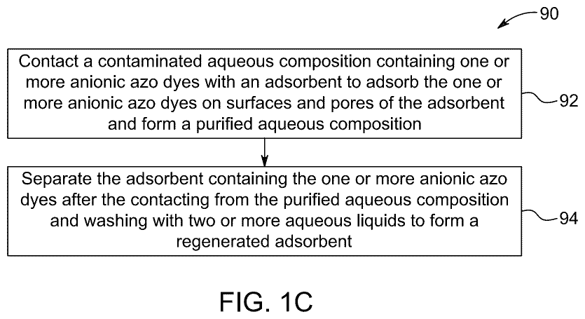

Referring to FIG. 1A, a method 50 of preparing the ZIF-8@MnCuAl-LTH is described. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes dispersing zeolitic imidazolate framework-8 (ZIF-8) in the form of particles in an alkaline solution to form a first dispersion. The ZIF-8 particles may be dispersed into the alkaline solution via stirring/swirling/agitating/mixing/sonication, to form the first dispersion. The alkaline solution comprises two or more inorganic salts selected from the group consisting of sodium carbonate, sodium bicarbonate, sodium hydroxide, potassium carbonate, potassium bicarbonate, and potassium hydroxide. In a preferred embodiment, the inorganic salts are sodium carbonate and sodium hydroxide. The molar ratio of sodium hydroxide to sodium carbonate is in the range of 10:1 to 20:1, preferably 11:1 to 19:1, preferably 12:1 to 18:1, preferably 13:1 to 17:1, preferably 14:1-16:1, and more preferably of about 16.1. Other ranges are also possible. The pH of the alkaline solution is in the range of 8-14, preferably 9-13, preferably 10-12, and more preferably between 10-11. Other ranges are also possible.

At step 54, the method 50 includes mixing a manganese salt, a copper salt, and an aluminum salt in water to form an aqueous salt solution. Suitable examples of manganese salts include manganese sulfate, manganese chloride, manganese nitrite, manganese nitrate, manganese acetylacetonate, manganese acetate, and mixtures and hydrates thereof. Preferably, the manganese salt is manganese nitrate, and more preferably manganese nitrate hexahydrate. Suitable examples of the copper salt include, but are not limited to, copper sulfate, copper nitrate, copper chloride, copper acetate, copper carbonate, copper phosphate, and/or a hydrate thereof. In a preferred embodiment, the copper salt is copper nitrate, and more specifically, copper nitrate trihydrate. Suitable examples of the aluminum salt include, but are not limited to, aluminum chloride, aluminum bromide, aluminum iodide, aluminum fluoride, aluminum nitrate, aluminum acetate, aluminum formate, aluminum sulphate, and/or combinations thereof. In a preferred embodiment, the aluminum salt is aluminum nitrate, specifically, aluminum nitrate nonahydrate. The molar ratio of the manganese salt to the copper salt is in a range of 1:5 to 5:1, preferably 1:3 to 3:1, preferably 1:2 to 2:1, preferably 2:1. Other ranges are also possible. In some embodiments, the molar ratio of the manganese salt to the aluminum salt is in a range of 1:5 to 5:1, preferably 1:3 to 3:1, preferably 1:2 to 2:1, preferably 1:1. Other ranges are also possible.

At step 56, the method 50 includes simultaneously dropwise adding and mixing the aqueous salt solution, and the alkaline solution to the first dispersion to form a reaction mixture. The reaction mixture was mixed for 10-60 minutes, preferably 20-40 minutes, preferably for about 30 minutes at room temperature. Other ranges are also possible. During the entire addition and mixing process, the pH of the reaction mixture was maintained between 8-13, preferably 9-12, preferably 10-11. Other ranges are also possible.

At step 58, the method 50 includes heating the reaction mixture at a temperature of 70 to 150 degrees Celsius (° C.), preferably 80-140° C., preferably 90-130° C., preferably 100-120° C., preferably for about 120° C. Other ranges are also possible. The reaction mixture was heated in a Teflon-lined autoclave or any other pressure containers for 12-36 hours, preferably 18-30 hours, preferably 24 hours ZIF-8 @MnCuAl-LTH. Other ranges are also possible. In some embodiments, the ZIF-8@MnCuAl-LTH was recovered from the reaction mixture via filtration/centrifugation, preferably centrifugation. The recovered ZIF-8 @MnCuAl-LTH may be further washed with water to remove any unreacted reactants/impurities and dried to obtain a regenerated ZIF-8@MnCuAl-LTH. The drying may be carried out using heating appliances such as ovens, microwaves, autoclaves, hot plates, heating mantles and tapes, oil baths, salt baths, sand baths, air baths, hot-tube furnaces, and hot-air guns. The regenerated ZIF-8 @MnCuAl-LTH is further ground to a fine powder to reduce its particle size. The particle size may be reduced by ball milling, grinding, pressure homogenization, or a combination thereof. The small particle size of the nanocomposite imparts a high surface area and increased pore volume, resulting in an improved adsorptive capacity of the regenerated ZIF-8@MnCuAl-LTH towards anionic dyes, such as acid red (AR1), when used for water treatment.

Referring to FIG. 1B, a method 70 of preparing the MnCuAl-LTH@ZIF-8 is described. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes mixing a manganese salt, a copper salt, and an aluminum salt in water to form an aqueous salt solution. Suitable examples of manganese salts include manganese sulfate, manganese chloride, manganese nitrite, manganese nitrate, manganese acetylacetonate, manganese acetate, and mixtures and hydrates thereof. Preferably, the manganese salt is manganese nitrate, and more preferably manganese nitrate hexahydrate. Suitable examples of the copper salt include, but are not limited to, copper sulfate, copper nitrate, copper chloride, copper acetate, copper carbonate, copper phosphate, and/or a hydrate thereof. In a preferred embodiment, the copper salt is copper nitrate, and more specifically, copper nitrate trihydrate. Suitable examples of the aluminum salt include, but are not limited to, aluminum chloride, aluminum bromide, aluminum iodide, aluminum fluoride, aluminum nitrate, aluminum acetate, aluminum formate, aluminum sulphate, and/or combinations thereof. In a preferred embodiment, the aluminum salt is aluminum nitrate, specifically, aluminum nitrate nonahydrate. The molar ratio of the manganese salt to the copper salt in the aqueous salt solution is in a range of 1:5 to 5:1, preferably 1:3 to 3:1, preferably 1:2 to 2:1, preferably 2:1. Other ranges are also possible. In some embodiments, the molar ratio of the manganese salt to the aluminum salt in the aqueous salt solution is in a range of 1:5 to 5:1, preferably 1:3 to 3:1, preferably 1:2 to 2:1, preferably 1:1. Other ranges are also possible.

At step 74, the method 70 includes mixing the aqueous salt solution and an alkaline solution to form a reaction mixture, heating, and drying to form a MnCuAl layered triple hydroxide modified zeolitic composite (MnCuAl-LTH) in the form of particles. In some embodiments, the alkaline solution comprises two or more inorganic salts selected from the group consisting of sodium carbonate, sodium bicarbonate, sodium hydroxide, potassium carbonate, potassium bicarbonate, and potassium hydroxide. In a preferred embodiment, the inorganic salts are sodium carbonate and sodium hydroxide. In some embodiments, the molar ratio of sodium hydroxide to sodium carbonate is in the range of 10:1 to 20:1, preferably 11:1 to 19:1, preferably 12:1 to 18:1, preferably 13:1 to 17:1, preferably 14:1-16:1, and more preferably of about 16.1. Other ranges are also possible. In some embodiments, the pH of the alkaline solution is in the range of 8-14, preferably 9-13, preferably 10-12, and more preferably between 10-11. Other ranges are also possible.

The aqueous salt solution and the alkaline solution are heated to a temperature range of 70 to 150 degrees Celsius (° C.), preferably 80-140° C., preferably 90-130° C., preferably 100-120° C., preferably for about 120° C. in a Teflon-lined autoclave or any other pressure containers for 12-36 hours, preferably 18-30 hours, preferably 24 hours to obtain the MnCuAl-LTH. The MnCuAl-LTH includes particles of MnCuAl-LTH. Other ranges are also possible.

In some embodiments, the MnCuAl-LTH is calcined at a temperature of about 400 to 600° C. to form the MnCuAl layered triple oxide modified zeolitic composite (MnCuAl-LTO). As used herein, the term ‘calcination’ refers to the thermal treatment of a solid form of the MnCuAl-LTH particles, whereby the MnCuAl-LTH particles are heated to a high temperature without melting under a restricted supply of ambient oxygen, generally for the purpose of removing impurities or volatile substances and to incur thermal decomposition. During this process, the MnCuAl-LTH particles are heated to a temperature of 400 to 600° C., preferably 450-550° C., preferably 500° C. for 2-6 hours, preferably 4 hours. Other ranges are also possible. The calcination may be performed by any conventional method or apparatus known to a person skilled in the art, for example, but not limited to, using a muffle furnace, electric furnace, tube furnace, box furnace, crucible furnace, microwave furnace, vacuum furnace, rotary kiln, or fluidized bed furnace.

At step 76, the method 70 includes dispersing particles of the MnCuAl-LTH in water to form a dispersion. In a preferred embodiment, the particles are dispersed in water and agitated via sonication.

At step 78, the method 70 includes mixing a zinc salt aqueous solution, an imidazole solution, and the dispersion thereby reacting to form the MnCuAl-LTH@ZIF-8. In a preferred embodiment, the zinc salt is a hydrated zinc salt. Suitable examples of hydrated zinc salts include zinc sulfate heptahydrate (ZnSO₄·7H₂O), zinc nitrate hexahydrate (Zn(NO₃)₂·6H₂O), zinc acetate dihydrate (Zn(CH₃CO₂)₂), zinc oxalate dihydrate (ZnC₂O₄·2H₂O), zinc acetylacetonate hydrate Zn(C₅H₇O₂)2·xH₂O. In an embodiment, the hydrated zinc salt is a nitrate salt. In a preferred embodiment, the hydrated zinc salt is Zn(NO₃)₂·6H₂O. The aqueous solution is water. The imidazole solution includes a ligand selected from imidazoles, 2-methylimidazole, nitroimidazole, benzimidazole, 4-methylimidazole, 4-nitro imidazole, N-propyl imidazole, preferably 2-methylimidazole. The imidazole solution may optionally include a surfactant. Preferred examples of the surfactant include cetyltrimethylammonium bromide, hexadecyltrimethylammonium chloride, kayexalate, lauryl sodium sulfate, neopelex, etc. In some embodiments, the molar ratio of the zinc salt to the ligand in the imidazole solution is in the range of 1:5 to 5:1, preferably 1:4 to 4:1, preferably 1:4. Other ranges are also possible. The mixing was carried out for 1-4 hours to obtain the MnCuAl-LTH@ZIF-8. Other ranges are also possible.

The MnCuAl-LTH@ZIF-8 may be recovered from the reaction mixture via filtration/centrifugation, preferably centrifugation. The recovered MnCuAl-LTH@ZIF-8 may be further washed with water to remove any unreacted reactants/impurities and dried to obtain a regenerated MnCuAl-LTH@ZIF-8. The drying may be carried out using heating appliances such as ovens, microwaves, autoclaves, hot plates, heating mantles and tapes, oil baths, salt baths, sand baths, air baths, hot-tube furnaces, and hot-air guns. The regenerated MnCuAl-LTH@ZIF-8 is further ground to a fine powder to reduce its particle size. The particle size may be reduced by ball milling, grinding, pressure homogenization, or a combination thereof. The small particle size of the nanocomposite imparts a high surface area and increased pore volume, resulting in an improved adsorptive capacity of the regenerated MnCuAl-LTH@ZIF-8 composite towards anionic dyes, such as acid red (AR1), when used for water treatment.

Referring to FIG. 1C, a water treatment method is described. The order in which the method 90 is described is not intended to be construed as a limitation, and any number of the described method steps can be combined in any order to implement the method 90. Additionally, individual steps may be removed or skipped from the method 90 without departing from the spirit and scope of the present disclosure.

At step 92, the method 90 includes contacting a contaminated aqueous composition containing one or more anionic azo dyes with an adsorbent to adsorb the one or more anionic azo dyes on surfaces and pores of the adsorbent and form a purified aqueous composition. In some embodiments, the aqueous solution includes water. The water may be tap water, distilled water, bi-distilled water, deionized water, de-ionized distilled water, reverse osmosis water, seawater, lake water, and/or some other water. In some embodiments, the water may be contaminated with one or more anionic azo dyes. Suitable examples of the anionic azo dyes include but are not limited to, acid red 1 (AR1), acid orange 7, acid red 73, acid yellow 36, acid blue 9, acid black 1, reactive orange 16, naphthol blue-black, acid orange 52, amaranth, reactive red-P2B, reactive black 5, congo red (CR), orange (II), methyl red, and/or combinations thereof. In a preferred embodiment, the anionic azo dye is AR1. In some embodiments, the concentration of the anionic azo dyes in the contaminated aqueous composition in an amount of 10 to 1000 parts per million (ppm) based on the total weight of the contaminated aqueous composition, preferably 100 to 800 ppm, preferably 200 to 700 ppm, preferably 300 to 600 ppm, or even more preferably 400 to 500 ppm.

Contacting the adsorbent with the aqueous composition results in the sorption (preferably adsorption) of the anionic azo dyes present in the contaminated aqueous solution onto the surfaces and pores of the adsorbent to form the purified composition. Sorption mechanisms include Van der Waals attractions, hydrophobic bonding, hydrogen bonding, charge transfer, ion exchange, and ligand exchange.

One of the factors that affect the adsorption performance of the adsorbent is the pH. The adsorbent of the present disclosure has an adsorption capacity in a range of 50 to 700 milligrams of the anionic azo dyes per gram of the adsorbent (mg/g) in the contaminated aqueous composition having a pH of 4 to 12. As used herein, “adsorption capacity” refers to the amount of adsorbate taken up by the adsorbent per unit mass (or volume) of the adsorbent. In a specific embodiment, the adsorbent, ZIF-8@MnCuAl-LTH, has an adsorption capacity of about 600 to 700 mg/g, preferably 610-690 mg/g, preferably 620-680 mg/g, preferably 630-670 mg/g, preferably 640-660 mg/g, preferably 664.5 at a pH of about 8. Other ranges are also possible. The adsorbent containing the anionic dyes may also be referred to as a spent adsorbent. The spent adsorbent may be regenerated for further re-use.

At step 94, the method 90 includes separating the adsorbent containing the one or more anionic azo dyes after the contacting from the purified aqueous composition and washing with two or more aqueous liquids to form a regenerated adsorbent. In other words, the adsorbent may be regenerated by washing the spent adsorbent with two or more aqueous liquids. The aqueous liquids are selected from the group consisting of water, methanol, ethanol, propanol, butanol, pentanol, hexanol, and isomers and mixtures thereof. In a preferred embodiment, the aqueous fluids are ethanol and water. In a preferred embodiment, the spent adsorbent can be repeatedly washed with a mixture of ethanol and water. In some embodiments, the spent adsorbent may be washed with ethanol, followed by water, to regenerate the adsorbent. The regenerated adsorbent has a dye removal rate of at least 70%, preferably 71%, preferably 72%, preferably about 73%, based on an initial concentration of the anionic azo dyes present in the contaminated aqueous composition after 2 to 20 cycles, preferably 3 to 15 cycles, preferably 4 to 10 cycles, or even more preferably about 5 cycles of adsorption. Other ranges are also possible.

### EXAMPLES

The following examples demonstrate a water treatment method using a modified zeolitic imidazolate framework-8, as described herein. The examples are provided solely for illustration and are not to be construed as limitations of the present disclosure, as many variations thereof are possible without departing from the spirit and scope of the present disclosure.

### Example 1: Synthesis of ZIF-8@MnCuAl-LTH

The synthesis of ZIF-8@MnCuAl-LTH was carried out according to the following procedure. Briefly, the pH of 100 mL distilled water was adjusted to 10-11 using solution A (composed of e.g., preferably about 27.9 mM sodium carbonate and preferably about 446.4 mM sodium hydroxide), then a certain amount of as-synthesized ZIF-8 was dispersed in this solution using sonication. Then, solution A and solution B (composed of e.g., preferably about 111.6 mM Mn(NO₃)₂·6H₂O, preferably about 55.8 mM Cu(NO₃)₂·3H₂O, and preferably about 55.8 mM Al(NO₃)₃·9H₂O) were added simultaneously (in a dropwise manner) to ZIF-8 dispersion while maintaining the pH of the reaction mixture at 10-11 by controlling the addition rate of solution A and B. The mixture was continuously stirred during the addition of solutions A and B. After adding solutions A and B, the mixture was stirred at room temperature for 30 minutes. Then, the formed suspension was transferred into a Teflon-lined autoclave reactor and kept in an oven at 120° C. for 24 h. Finally, the ZIF-8@MnCuAl-LTH composite that was produced was recovered using centrifugation and washed several times with distilled water. The collected ZIF-8 @MnCuAl-LTH solid was dried at preferably about 80° C., followed by grinding into a fine powder.

### Example 2: Synthesis of MnCuAl-LTH

The synthesis of MnCuAl-LTH was carried out according to the following procedure. Briefly, the pH of 100 mL distilled water was adjusted to 10-11 using solution A (composed of e.g., preferably about 27.9 mM sodium carbonate and preferably about 446.4 mM sodium hydroxide). Then, solution A and solution B (composed of e.g., preferably about 111.6 mM Mn(NO₃)₂·6H₂O, preferably about 55.8 mM Cu(NO₃)₂·3H₂O, and preferably about 55.8 mM Al(NO₃)₃·9H₂O) were mixed while maintaining the pH of the reaction mixture at 10-11 by controlling the addition rate of solution A and B. The mixture was continuously stirred during the addition of solutions A and B. After adding solutions A and B, the mixture was stirred at room temperature for 30 minutes. Then, the formed suspension was transferred into a Teflon-lined autoclave reactor and kept in an oven at 120° C. for 24 h. Finally, the MnCuAl-LTH composite that was produced was recovered using centrifugation and washed several times with distilled water. The collected MnCuAl-LTH solid was dried at preferably about 80° C., followed by grinding into a fine powder. The synthesis of the pristine MnCuAl-LTH followed the same procedure but without the addition of ZIF-8.

### Example 3: Synthesis of MnCuAl-LTO

The MnCuAl-LTH from Example 2 was calcined at a temperature of about 500° C. for about 4 h, resulting in the formation of mixed metal oxides, abbreviated as MnCuAl-LTO.

### Example 4: Synthesis of MnCuAl-LTH@ZIF-8

Initially, MnCuAl-LTH was dispersed in 100 mL distilled water solution using sonication. Then, Zn(NO₃)₂·6H₂O aqueous solution (40 mmol in 80 mL distilled water) was added to the above dispersion; the new mixture was further sonicated for 10 min. Then, 2-methyl imidazole solution (160 mmol in 135 mL of 28% ammonia solution) was added to the above mixture, followed by stirring at room temperature for 1 h, then aging under standstill condition for 3 h. The MnCuAl-LTH@ZIF-8 was recovered using centrifugation and washed with distilled water until the pH of the supernatant dropped to about 7. The collected MnCuAl-LTH@ZIF-8 solid was dried at 80° C., followed by grinding into a fine powder.

### Example 5: Synthesis of MnCuAl-LTO@ZIF-8

Initially, MnCuAl-LTO was dispersed in 100 mL distilled water solution using sonication. Then, Zn(NO₃)₂·6H₂O aqueous solution (40 mmol in 80 mL distilled water) was added to the above dispersion; the new mixture was further sonicated for 10 min. Then, 2-methyl imidazole solution (160 mmol in 135 mL of 28% ammonia solution) was added to the above mixture, followed by stirring at room temperature for 1 h, then aging under standstill condition for 3 h. The MnCuAl-LTO@ZIF-8 was recovered using centrifugation and washed with distilled water until the pH of the supernatant dropped to about 7. The collected MnCuAl-LTO@ZIF-8 solid was dried at 80° C., followed by grinding into a fine powder. Additionally, pristine ZIF-8 was synthesized using a similar method but without adding MnCuAl-LTH or MnCuAl-LTO.

### Example 6: Characterization

X-ray diffractometer (XRD) was used to study the crystallinity of the synthesized materials. In this characterization, CuKα1 radiation of 40 kV and a current of 15 mA were applied. The scanning rate was 7.00°/min over a 2θ angle range of 5-70°. In addition to XRD, Fourier Transform Infrared (FTIR) spectroscopy was also conducted to probe functional groups on the surfaces of the prepared materials. The FTIR spectra were recorded in the wavenumber range of 500-4000 cm⁻¹. Additionally, the textural properties (i.e., pore volume, pore size, and specific surface area) of the synthesized composites were obtained using the standard multipoint Brunauer-Emmett-Teller (BET) method via the N₂ adsorption/desorption measurements conducted at a temperature of 77 K.

### Example 7: Zeta Potential

Zeta potential measurements were conducted to determine the point of zero charge for each of the synthesized materials (i.e., ZIF-8, MnCuAl-LTH, MnCuAl-LTO, MnCuAl-LTH@ZIF-8, MnCuAl-LTO@ZIF-8, and ZIF-8@MnCuAl-LTH ZIF-8). In each measurement, an aqueous solution containing 1 mM NaCl as the background electrolyte was initially purged with N₂ for 3 min to remove dissolved gases (e.g., CO₂ and O₂). After purging, the initial pH of the aqueous solution was adjusted to either 4, 5, 6, 8, 9, 10, and 12; 100 mM HCl or NaOH was used for pH adjustment. Then, 50 mg of each synthesized material was added to 100 mL of each pH-adjusted aqueous solution, making the adsorbent concentration of 50 mg/L. Then, another purging with N₂ was conducted. The purged samples were then placed on a shaker with a shaking speed of 250 rpm for 24 h. Finally, each sample was sonicated for 7 min, followed by immediate zeta potential measurements.

### Example 8: Adsorption Tests

Adsorption experiments were carried out to benchmark the performance of the synthesized composites (i.e., MnCuAl-LTH@ZIF-8, MnCuAl-LTO@ZIF-8, and ZIF-8@MnCuAl-LTH composites) to the pristine ones (ZIF-8, MnCuAl-LTH, and MnCuAl-LTO) in removing AR1 dye from synthetic wastewater samples containing 100 ppm of this dye. The dosage of each adsorbent was fixed at 50 mg/L. After each of the above and the subsequent experiments, an aliquot was taken from each sample, filtered, and analyzed using UV-Vis spectroscopy to determine the residual AR1 concentration. Based on the results, the ZIF-8@MnCuAl-LTH was an effective adsorbent. Experiments were conducted in stoppered conical flasks at a shaking speed of 250 rpm using an orbital shaker for 24 h, unless stated otherwise. After determining the effective AR1 adsorbent (i.e., ZIF-8@MnCuAl-LTH), the optimum pH was determined by varying the pH of the AR1 aqueous solution in the range from 4 to 12. This pH study showed that the optimum pH is e.g., preferably about 8, and accordingly, all the subsequent experiments (i.e., isotherm, kinetics, and regeneration) were conducted at this pH value.

The regenerability and reusability of the ZIF-8@MnCuAl-LTH composite was assessed by conducting e.g., two to twenty cycles, or even more preferably about five cycles of adsorption-desorption process. After each cycle, the adsorbent was recovered using centrifugation, washed three times with ethanol followed by several rinses with distilled water, and dried at 50° C. for one day.

### Example 9: XRD Results

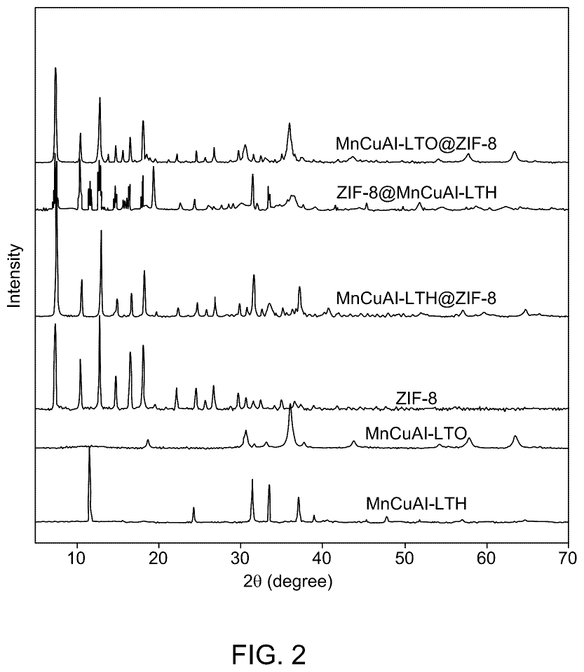

FIG. 2 depicts the XRD diffraction patterns of the MnCuAl-LTO@ZIF-8, the ZIF-8@MnCuAl-LTH, the MnCuAl-LTH@ZIF-8, ZIF-87, MnCuAl-LTO, and MnCuAl-LTH. The results (See: A. Al-Fakih, W. Al-Awsh, M. Q. Ahmed Al-Koshab, M. A. Al-Shugaa, M. A. Al-Osta, Q. A. Drmosh, A. E. S. Musa, M. A. Abdulqader, M. A. A. Elgzoly, S. A. Onaizi, Effects of zeolitic imidazolate framework-8 nanoparticles on physicomechanical properties and microstructure of limestone calcined clay cement mortar, Construction and Building Materials, 366 (2023) 130236, which is incorporated herein by reference in its entirety), showing that ZIF-8 was successfully synthesized. The ZIF-8 has a cubic structure with cell parameters of a=b=c=17.038 Å, α=β=γ=90°, and a space group of 217: I-43m. In addition, the ZIF-8 XRD pattern reveals sharp and strong peaks at 2θ of 7.34, 10.34, and 12.72. 14.69, 16.44, 18.02, 19.48, and 20.83°, which are related to (110), (200), (211), (220), (310), (220), (321), and (400) crystal planes, respectively, showing the high crystallinity of ZIF-8 (See: X. Liang, Y. Su, X. Wang, C. Liang, C. Tang, J. Wei, K. Liu, J. Ma, F. Yu, Y. Li, Insights into the heavy metal adsorption and immobilization mechanisms of CaFe-layered double hydroxide corn straw biochar: Synthesis and application in a combined heavy metal-contaminated environment, Chemosphere, 313 (2023) 13746, which is incorporated herein by reference in its entirety). The sharp diffraction peaks located at 2θ=14.41, 33.20, 35.28, and 38.14° in the MnCuAl-LTH XRD pattern stem from the (003), (012), (009), and (015) lattice planes of MnCuAl-LTH structure, which are the typical peaks of layered double/triple hydroxide compounds. Peaks with lower 2θ values are sharper and more symmetrical than those at higher diffraction angles as shown in FIG. 2 (See: A. Chatla, I. W. Almanassra, V. Kochkodan, T. Laoui, r, H. Alawadhi, M. A. Atieh, Efficient removal of Eriochrome Black T (EBT) dye and Chromium (Cr) by hydrotalcite-derived Mg-Ca-Al mixed metal oxide composite, Catalysts, (2022); and M. Mubarak, H. Jeon, M. S. Islam, C. Yoon, J.-S. Bae, S.-J. Hwang, W. S. Choi, H.-J. Lee, One-pot synthesis of layered double hydroxide hollow nanospheres with ultrafast removal efficiency for heavy metal ions and organic contaminants, Chemosphere, 201 (2018) 676-686, each of which is incorporated herein by reference in their entireties), showing that the synthesized MnCuAl-LTH has a hydrotalcite crystal structure. The clean diffraction pattern without additional peaks indicates that the produced MnCuAl-LTH sample is crystalline in nature and of high purity. After calcination, the MnCuAl-LTH is transformed into mixed metal oxides (abbreviated as MnCuAl-LTO) with poor crystallinity, as indicated by the MnCuAl-LTO XRD pattern shown in FIG. 2. Furthermore, the existence of metal oxides is corroborated by the two peaks at 20θ of 58 and 65° (See: D. Gherca, M. Porcescu, D.-D. Herea, H. Chiriac, N. Lupu, G. Buema, Superior efficacies adsorptions on hydrotalcite-like compound as dual-functional clay nanomaterial for heavy metals and anionic dyes, Applied Clay Science, 233 (2023) 106841, which is incorporated herein by reference in its entirety). However, due to the partial MnCuAl-LTH destruction, MnCuAl-LTO exhibited some weak diffraction peaks comparable to parent MnCuAl-LTH (See: A. Chatla, I. W. Almanassra, V. Kochkodan, T. Laoui, r, H. Alawadhi, M. A. Atieh, Efficient removal of Eriochrome Black T (EBT) dye and Chromium (Cr) by hydrotalcite-derived Mg-Ca-Al mixed metal oxide composite, Catalysts, (2022); and B. Zeng, Q. Wang, L. Mo, F. Jin, J. Zhu, M. Tang, Synthesis of Mg-Al LDH and its calcined form with natural materials for efficient Cr(VI) removal, Journal of Environmental Chemical Engineering, 10 (2022) 108605, each of which is incorporated herein by reference in their entireties).

The MnCuAl-LTH@ZIF-8 and the MnCuAl-LTO@ZIF-8 have similar diffraction patterns to their parental materials, indicating the formation of composites, whereas the diffraction peaks of ZIF-8 did not appear in the XRD pattern of the ZIF-8 @MnCuAl-LTH composite, mostly likely because the thickness of the ZIF-8 shell was insufficient to create strong scattering crystalline peaks (See: B. Zhang, W. Liu, D. Sun, Y. Li, T. Wu, Hollow nanoshell of layered double oxides for removal of 2,4-dichlorophenol from aqueous solution: Synthesis, characterization, and adsorption performance study, Colloids and Surfaces A: Physicochemical and Engineering Aspects, 561 (2019) 244-253, which is incorporated herein by reference in its entirety).

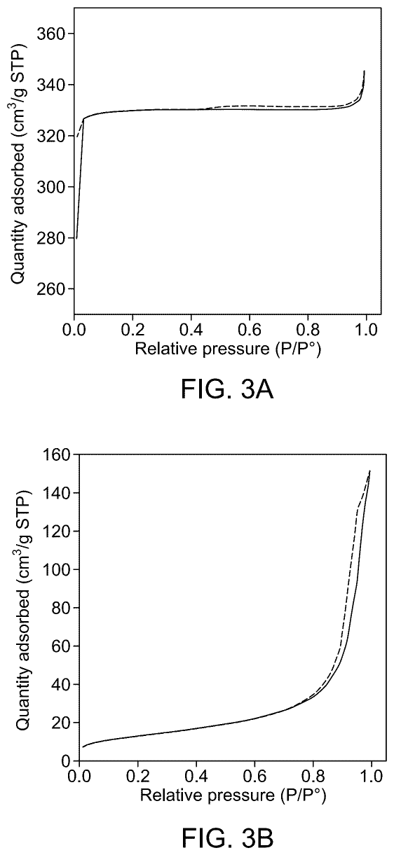

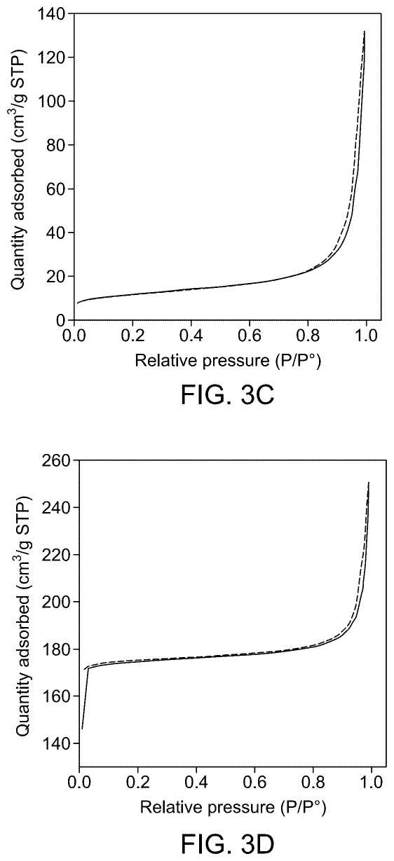

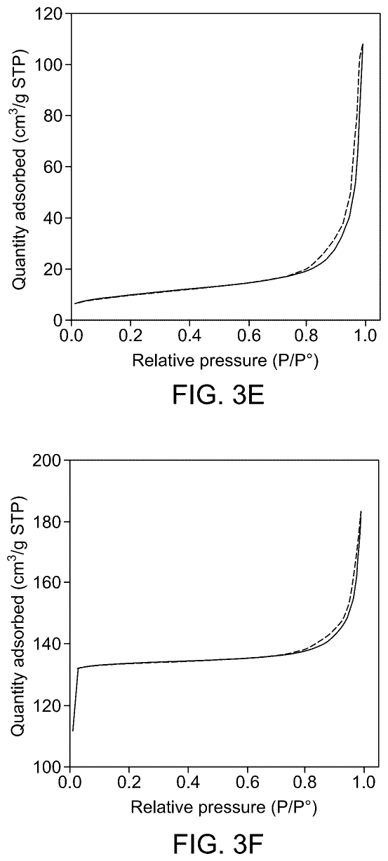

The textural properties of the composites—MnCuAl-LTO@ZIF-8, ZIF-8@MnCuAl-LTH, MnCuAl-LTH@ZIF-8, and their parental materials, ZIF-8, MnCuAl-LTO, and MnCuAl-LTH were obtained using the N₂ adsorption-desorption isotherms as shown in FIG. 3. The N₂ adsorption isotherm on ZIF-8 fits the prototypical Type I category with an H4-type hysteresis loop, as defined by the IUPAC classification [See: M. M. Rahman, A. Z. Shafiullah, A. Pal, M. A. Islam, I. Jahan, B. B. Saha, Study on Optimum IUPAC Adsorption Isotherm Models Employing Sensitivity of Parameters for Rigorous Adsorption System Performance Evaluation, Energies, 14 (2021) 7478, which is incorporated herein by reference in its entirety]. At P/P₀>0.5, the hysteresis loop was extremely narrow, indicating that only a microporous structure exists in ZIF-(FIG. 3A). The N₂ adsorption isotherms for MnCuAl-LTO and MnCuAl-LTH show Type III with H3 narrow hysteresis loop at P/P₀>0.8, which is consistent with the presence of cage-type mesopores and macropores (FIG. 3B and FIG. 3C, respectively). The ZIF-8@MnCuAl-LTH composite shows a Type III isotherm with a bit wide hysteresis loop at P/P₀>0.8, indicating the predominance of a mesoporous structure in this composite (FIG. 3D). The N₂ adsorption isotherms for MnCuAl-LTH@ZIF-8 and MnCuAl-LTO@ZIF-8 are a combination of Type I and Type III isotherms and are best fit by the Type II (Sigmoid) isotherm. This may be due to the expansion of ZIF-8 onto MnCuAl-LTH and MnCuAl-LTO (FIG. 3E and FIG. 3F, respectively).

Table 1 displays the calculated Langmuir and BET-specific surface area, cumulative pore volume, and average pore diameter of the synthesized materials. As displayed in Table 1, ZIF-8 modification results in a 12-13% increase in surface area for MnCuAl-LTH and MnCuAl-LTO, with the exception of the ZIF-8@MnCuAl-LTH, which experiences an increase of about 1.3%. This might be because of the expansion of the various composites described above. ZIF-8 underwent a modification process that reduced its surface areas and pore volume (Table 1). Additionally, although the ZIF-8@MnCuAl-LTH has the lowest surface area of the synthesized composites, it has the highest pore volume. This lines up with the hysteresis loop finding in FIG. 3. Based on pore diameter, all the synthesized materials, except the pristine ZIF-8, can be categorized as mesoporous according to the IUPAC classification because their average pore sizes are between 2 and 50 nm; ZIF-8 is classified as microporous material with an average pore diameter of 1.71 nm. These alterations of the textural properties of the parental materials (i.e., ZIF-8, MnCuAl-LTH and MnCuAl-LTO) upon the formation of the composites (i.e., ZIF-8@MnCuAl-LTH, MnCuAl-LTH@ZIF-8, and MnCuAl-LTO@ZIF-8) might improve their adsorption performance.

TABLE 1
Textural properties of the synthesized composites and their parental materials.

| | Langmuir | Langmuir | Cumulative | |
|---|---|---|---|---|
| | surface area | surface area | pore volume | Average pore |
| Material | (m²/g) | (m²/g) | (cm³/g) | diameter (nm) |
| ZIF-8@MnCuAl-LTH | 67.6 | 45.8 | 0.236 | 17.6 |
| MnCuAl-LTH@ZIF-8 | 766.0 | 639.1 | 0.125 | 28.3 |
| MnCuAl-LTO@ZIF-8 | 586.0 | 490.5 | 0.082 | 30.4 |
| ZIF-8 | 1442.0 | 1209.0 | 0.516 | 1.71 |
| MnCuAl-LTH | 57.6 | 42.0 | 0.201 | 27.0 |
| MnCuAl-LTO | 50.1 | 34.9 | 0.166 | 23.3 |

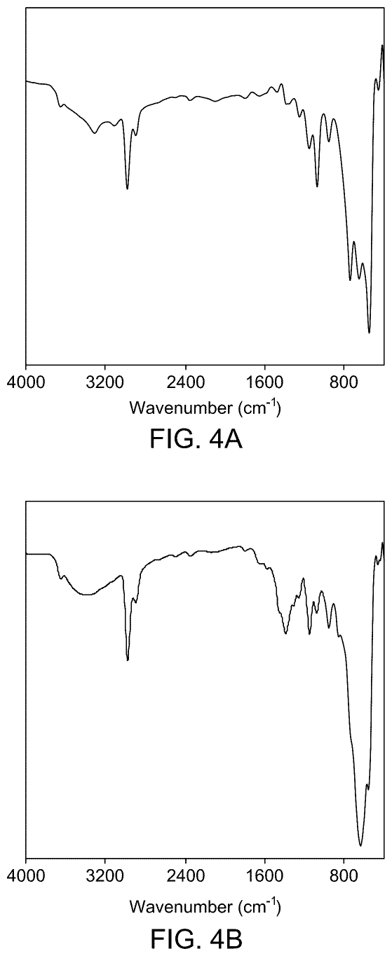

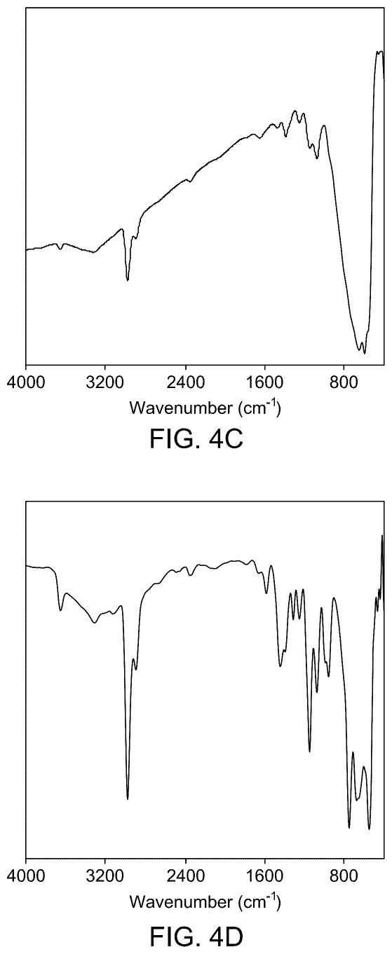

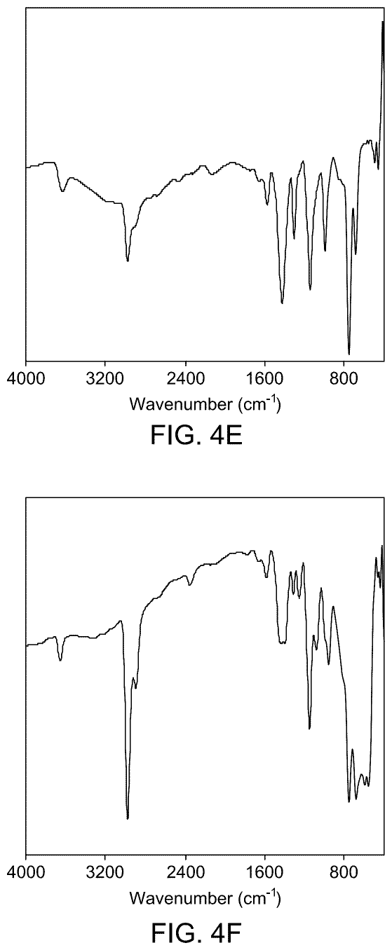

FIG. 4 depicts the functional groups found in ZIF-8 (FIG. 4C), MnCuAl-LTH (FIG. 4A), MnCuAl-LTO (FIG. 4B), and their composites utilizing the FT-IR in the 4000-400 cm⁻¹ range. The absorption bands found at 3487 cm⁻¹, 3135 cm⁻¹, and 2929 cm⁻¹ in the ZIF-8 FTIR spectrum correspond, respectively, to the N—H, aromatic, and aliphatic C—H stretching of the imidazole. The C═N stretching mode in the 2-methyl imidazole can be assigned to the absorption band at 1582 cm⁻¹. For the absorption band at 420 cm⁻¹, it is related to the Zn—N stretching mode. The C—N stretching was identified in the 1400-1100 cm⁻¹ range (See: B. Zhang, W. Liu, D. Sun, Y. Li, T. Wu, Hollow nanoshell of layered double oxides for removal of 2,4-dichlorophenol from aqueous solution: Synthesis, characterization, and adsorption performance study, Colloids and Surfaces A: Physicochemical and Engineering Aspects, 561 (2019) 244-253; and J. Panda, J. K Sahoo, P. K. Panda, a. N. SSahu, M. Samal, S. K. Pattanayak, R. Sahu, Adsorptive behavior of zeolitic imidazolate framework-8 towards anionic dye in aqueous media: Combined experimental and molecular docking study, Journal of Molecular Liquids 278 (2019) 536-545, each of which is incorporated herein by reference in their entireties). The aromatic ring stretching and bending are responsible for the bands at 1600-1400 cm⁻¹ and 800-700 cm⁻¹, respectively (See: R. M. M. d. Santos, R. G. L. Gongalves, V. R. L. Constantino, C. V. Santilli, P. D. Borges, J. Tronto, F. G. Pinto, Adsorption of Acid Yellow 42 dye on calcined layered double hydroxide: Effect of time, concentration, pH and temperature, Applied Clay Science, 140 (2017) 132-139, which is incorporated herein by reference in its entirety). The MnCuAl-LTH FT-IR spectrum exhibits prominent absorption bands in the region between 860-545 cm⁻¹ that can be attributed to metal-oxygen-metal and oxygen-metal-oxygen functional groups, such as Mn—O, Cu—O, and Al—O, as can be observed in FIG. 4A (See: A. Chatla, I. W. Almanassra, V. Kochkodan, T. Laoui, r, H. Alawadhi, M. A. Atieh, Efficient removal of Eriochrome Black T (EBT) dye and Chromium (Cr) by hydrotalcite-derived Mg-Ca-Al mixed metal oxide composite, Catalysts, (2022), which is incorporated herein by reference in its entirety). The absorption peaks at 1502 and 1383 cm⁻¹ are associated with the asymmetric stretching vibration of the interlayer carbonate ion (See: R. M. M. d. Santos, R. G. L. Gongalves, V. R. L. Constantino, C. V. Santilli, P. D. Borges, J. Tronto, F. G. Pinto, Adsorption of Acid Yellow 42 dye on calcined layered double hydroxide: Effect of time, concentration, pH and temperature, Applied Clay Science, 140 (2017) 132-139; and Y. Qiao, Q. Li, H. Chi, M. Li, Y. Lv, S. Feng, R. Zhu, K. Li, Methyl blue adsorption properties and bacteriostatic activities of Mg-Al layer oxides via a facile preparation method, Applied Clay Science, 163 (2018) 119-128, each of which is incorporated herein by reference in their entireties). The bands at 1502 and 1418 cm⁻¹ in the MnCuAl-LTO FT-IR spectrum also show the asymmetric stretching vibration of the interlayer carbonate ion (FIG. 4B). However, this band is much weaker compared to the MnCuAl-LTH, showing that the interlayer anions were eliminated during the calcination process, leaving just a small fraction of carbonate anions. Thus, the calcination process at 500° C. for 2 h could disrupt the crystal structure of LDH but does not result in the full loss of the interlayer carbonate anions.

Furthermore, the broad and strong absorption bands for metal-oxygen-metal and oxygen-metal-oxygen functional groups between 860-545 cm⁻¹ support the likelihood of the breakdown of the metal hydroxides in the MnCuAl-LTH into oxides. All of the characteristic peaks of ZIF-8 persisted in both composites of MnCuAl-LTH @ZIF-8 (FIG. 4E) and MnCuAl-LTO@ZIF-8 (FIG. 4F) FT-IR spectra, and both showed a substantially identical pattern of FTIR spectrum. Furthermore, two distinctive absorption bands of ZIF-8 occurred at 3600 and 2929 cm⁻¹, corresponding to stretching vibrations of N—H and aliphatic C—H, respectively, showing loading of ZIF-8 in the MnCuAl-LTH and MnCuAl-LTO composites. The ZIF-8@MnCuAl-LTH spectrum (FIG. 4D) shows generally similar absorption peaks to those of the unmodified MnCuAl-LTH. Additionally, the presence of a broad absorption peak in the range of 3800 to 3300 cm⁻¹ associated with the symmetric and asymmetric stretching vibrations of the N—H and O—H groups indicates the presence of ZIF-8, confirming the successful formation of the ZIF-8@MnCuAl-LTH composite.

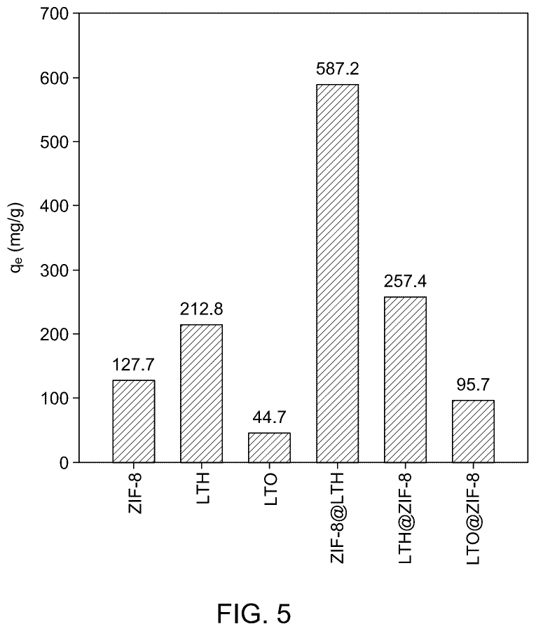

Tests were conducted in order to compare the AR1 adsorption performance of the composites (i.e., MnCuAl-LTH@ZIF-8, MnCuAl-LTO@ZIF-8, and ZIF-8@MnCuAl-LTH) to the pristine adsorbents/parental materials (ZIF-8, MnCuAl-LTH, and MnCuAl-LTO). FIG. 5 shows the adsorption of AR1 onto the composites as well as the pristine materials. According to the results presented in FIG. 5, the AR1 adsorption capacity on MnCuAl-LTO@ZIF-8 at the given experimental conditions is 95.7 mg/g relative to 127.7, and this composite outperforms MnCuAl-LTO, it is less effective than ZIF-8. Unlike MnCuAl-LTO@ZIF-8, the other two composites (i.e., MnCuAl-LTH@ZIF-8 and ZIF-8@MnCuAl-LTH) are superior to their parental materials (i.e., ZIF-8 and MnCuAl-LTH) with ZIF-8@MnCuAl-LTH being the effective AR1 adsorbent among all the synthesized materials.

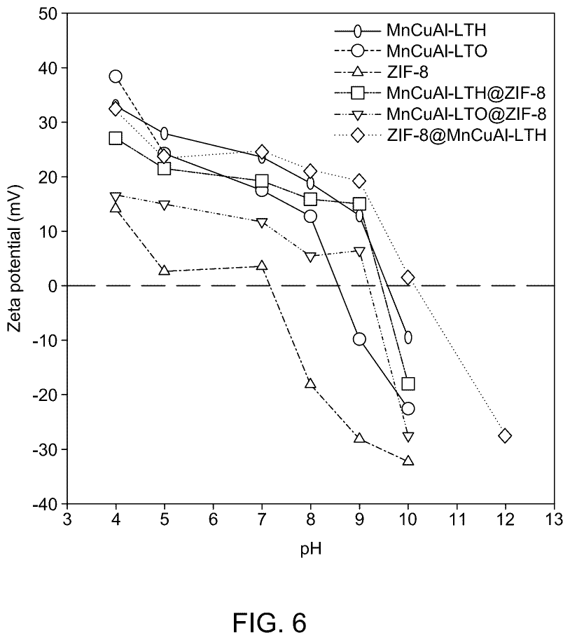

The superior adsorptive removal of AR1 using ZIF-8@MnCuAl-LTH over other composites might be ascribed to the high value of the pore volume in ZIF-8@MnCuAl-LTH compared to MnCuAl-LTH@ZIF-8 and MnCuAl-LTO@ZIF-8 as shown in Table 1. However, given that the molecular size of AR1 is 3×1.5×0.4 nm (See: T. Wang, P. Zhao, N. Lu, H. Chen, C. Zhang, X. Hou, Facile fabrication of Fe3O4/MIL-101(Cr) for effective removal of acid red 1 and orange G from aqueous solution, Chemical Engineering Journal, 295 (2016) 403-413, which is incorporated herein by reference in its entirety), which is smaller than the average pore size of all the utilized composites and pristine materials except ZIF-8, pore filling mechanism is unlikely to be the dominating one. Zeta potential measurements were conducted to test the electrostatic interaction on the synthesized materials at pH 6 (FIG. 6), and also to determine the point of zero charge (pH_{PZC}). FIG. 6 displays the obtained results from the zeta potential measurements, while Table 2 presents the obtained pH_{PZC} of the utilized adsorbents. The zeta potential values obtained pH 6 are also included in Table 2. According to the data presented in FIG. 6 and Table 2, all the utilized adsorbents are positively charged at pH 6, and thus, interacting attractively with the anionic AR1 dye (pKa of the AR1 sulfonate group is <1 (See: T. El Malah, H. F. Nour, E. K. Radwan, R. E. Abdel Mageid, T. A. Khattab, M. A. Olson, A bipyridinium- based polyhydrazone adsorbent that exhibits ultrahigh adsorption capacity for the anionic azo dye, direct blue 71, Chemical Engineering Journal, 409 (2021) 128195, which is incorporated herein by reference in its entirety), despite the variation of their positive charge intensity. Therefore, the high adsorption of AR1 onto ZIF-8@MnCuAl-LTH is unlikely to be mainly driven by electrostatic interaction, otherwise, AR1 adsorption onto MnCuAl-LTH, which carries slightly more positive charge (zeta potential of MnCuAl-LTH at pH 6 is 26.4 relative to 24.3 mV in the case of ZIF-8@MnCuAl-LTH), would be higher, which is not the case.

TABLE 2
Point of zero charge (pH_{PZC}) of the synthesized composites and their
parental materials, and their zeta potential values obtained at pH 6.

| Material | pH_{PZC} | Zeta potential at pH 6 (mV) |
|---|---|---|
| ZIF-8@MnCuAl-LTH | 10.1 | 24.3 |
| MnCuAl-LTH@ZIF-8 | 9.5 | 17.5 |
| MnCuAl-LTO@ZIF-8 | 9.2 | 10.9 |
| ZIF-8 | 7.2 | — |
| MnCuAl-LTH | 9.6 | 26.4 |
| MnCuAl-LTO | 8.6 | 15.6 |

### Example 10: ph Tests

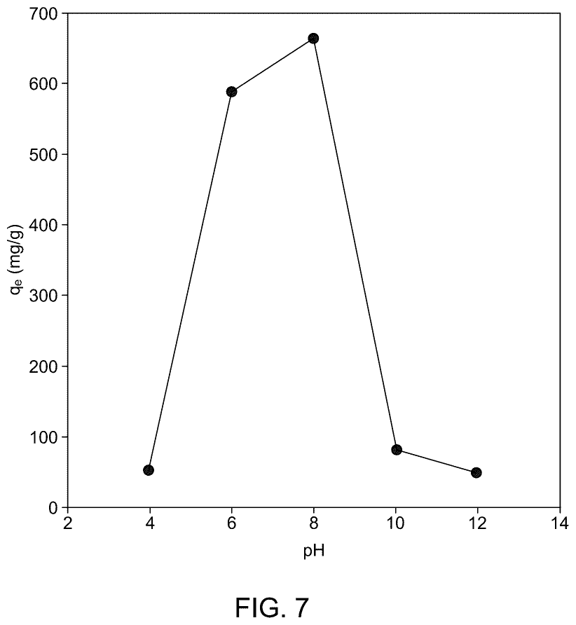

The pH of the adsorption medium affects both the adsorbent surface charge and the degree of adsorbate ionization (See: W. A. Al-Amrani, M. Hanafiah, P.-E. Lim, Influence of hydrophilicity/hydrophobicity on adsorption/desorption of sulfanilic acid using amine-modified silicas and granular activated carbon, Desal water treat, (2022) 1-10, which is incorporated herein by reference in its entirety). FIG. 7 shows the adsorption of AR1 onto the adsorbent, i.e., ZIF-8@MnCuAl-LTH composite at different pH values. Under the utilized experimental conditions, the adsorption capacity reached 664.5 mg/g at pH 8. The point of zero charge (pH_{pzc}) of ZIF-8@MnCuAl-LTH is about 10.1. Since AR1 is anionic dye, the electrostatic interaction between this dye and ZIF-8@MnCuAl-LTH should be attractive below pH_{pzc}. However, at pH values above the pH_{pzc}, electrostatic repulsion is seen. The highest electrostatic attractive interaction between AR1 and the ZIF-8@MnCuAl-LTH composite should take place at pH 4 at which the adsorbent carries more positive charge. However, the AR1 adsorption peaks up at pH 8; below and above this pH value, AR1 adsorption decreases.

At pH<8, the decrease in AR1 adsorption with lowering the medium pH might be due to the competition between H⁺ ions and the positively charged adsorbent to interact with the negatively charged sulfonate groups (—SO³⁻) of AR1. The sulfonate groups are very weak base and are stable anions down to a pH<1 (See: T. El Malah, H. F. Nour, E. K. Radwan, R. E. Abdel Mageid, T. A. Khattab, M. A. Olson, A bipyridinium-based polyhydrazone adsorbent that exhibits ultrahigh adsorption capacity for the anionic azo dye, direct blue 71, Chemical Engineering Journal, 409 (2021) 128195, which is incorporated herein by reference in its entirety). This competition masks the adsorption of AR1 onto ZIF-8@MnCuAl-LTH, which becomes more severe at low pH (i.e., pH 4). Conversely, the drop in AR1 adsorption upon increasing pH from 8 to 10 and above shows the increase in the repulsion forces between the −SO³⁻ groups of the dye and the gradual buildup of the negative charge on the adsorbent surface. However, given that the pH_{pzc} of ZIF-8@MnCuAl-LTH is 10.1, the drop in AR1 adsorption with increasing pH from 8 to 10 (i.e., qₑ at pH 10 is about 12% of that at pH 8) shows that electrostatic interaction is not the only mechanism in this adsorption process. Nonetheless, it shows that the effect of the involved mechanisms is optimized at pH 8. At this 8, the attraction forces between AR1 and the imidazole ring of ZIF-8@MnCuAl-LTH which includes π-π interactions and van der Waals force through the aromatic rings in the dye and the aromatic rings in imidazole of ZIF-8 are enhanced. Additionally, the adsorption process may be affected by the potential interaction between the zinc ion in the ZIF-8 structure as a Lewis acid and the sulfur, nitrogen, and oxygen sites of AR1 as a Lewis base. Furthermore, hydrogen bonding between ZIF-8 methyl groups and the —SO³⁻ of AR1 may also contribute to adsorption.

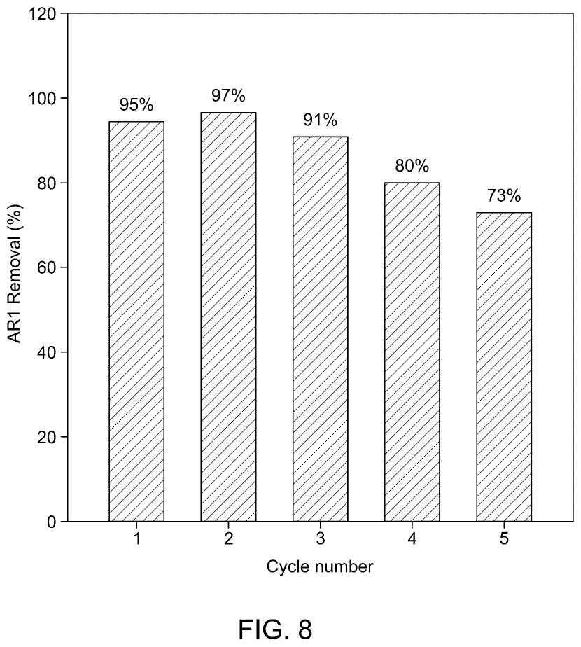

For wastewater management, adsorbents with high regeneration performance are preferred. For this purpose, the spent ZIF-8@MnCuAl-LTH composite was regenerated by repeatedly washing it with ethanol and distilled water after each adsorption cycle. FIG. 8 shows the results of ZIF-8@MnCuAl-LTH composite regeneration performance up to twenty, preferably up to five consecutive cycles. The physical and chemical structure of adsorbent may be compromised during the regeneration process, leading to diminished removal efficiency. In FIG. 8, maximum AR1 removal in the first, second, third, fourth, and fifth cycle was 95, 97, 91, 80, and 73%, respectively. Although the AR1 removal efficiency decreased by 22% (relative to the first cycle) after the fifth cycle, the performance of ZIF-8@MnCuAl-LTH is still enhanced. For example, the removal of acid blue red dye using ZIF-8@GO@APTES (ZGA) after the first, second, and third cycle was only 68.2, 59.1, and 55.2%, respectively (See: H. Hoseinzadeh, B. Hayati, F. Shahmoradi Ghaheh, K. Seifpanahi-Shabani, N. M. Mahmoodi, Development of room temperature synthesized and functionalized metal-organic framework/graphene oxide composite and pollutant adsorption ability, Materials Research Bulletin, 142 (2021) 111408, which is incorporated by reference in its entirety). Similarly, after three adsorption-desorption cycles, the adsorption capacity of blue 4 dye onto pristine ZIF-8 decreased by 30%, showing the blocking of adsorption sites (See: J. Panda, J. K Sahoo, P. K. Panda, a. N. SSahu, M. Samal, S. K. Pattanayak, R. Sahu, Adsorptive behavior of zeolitic imidazolate framework-8 towards anionic dye in aqueous media: Combined experimental and molecular docking study, Journal of Molecular Liquids 278 (2019) 536-545, which is incorporated by reference in its entirety). In the present disclosure, AR1 adsorptive removal dropped by 22% after five cycles. This shows the good reusability of the ZIF-8@MnCuAl-LTH composite, which is a key economic factor in practical wastewater treatment.

Numerous modifications and variations of the present disclosure are possible in light of the above teachings. It is, therefore, to be understood that within the scope of the appended claims, the invention may be practiced otherwise than as specifically described herein.

1: A water treatment method, comprising:
contacting a contaminated aqueous composition containing one or more anionic azo dyes with an adsorbent to adsorb the one or more anionic azo dyes on surfaces and pores of the adsorbent and form a purified aqueous composition;
wherein the adsorbent is at least one of a zeolitic imidazolate framework-8 modified MnCuAl layered triple hydroxide (ZIF-8@MnCuAl-LTH), a MnCuAl layered triple hydroxide modified zeolitic imidazolate framework-8 (MnCuAl-LTH@ZIF-8), and a MnCuAl layered triple oxide modified zeolitic imidazolate framework-8 (MnCuAl-LTO@ZIF-8); and
wherein the adsorbent has an adsorption capacity in a range of 50 to 700 milligrams the one or more anionic azo dyes per gram of the adsorbent (mg/g) in the contaminated aqueous composition having a pH of 4 to 12.

2: The method of claim 1, wherein the one or more anionic azo dyes are selected from the group consisting of acid red 1 (AR1), congo red, orange II, acid orange 7, acid red 73, acid yellow 36, acid blue 9, and acid black 1.

3: The method of claim 1, wherein the one or more anionic azo dyes are present in the contaminated aqueous composition in an amount of 10 to 1000 parts per million (ppm) based on a total weight of the contaminated aqueous composition.

4: The method of claim 1, wherein the adsorbent is a ZIF-8@MnCuAl-LTH, and wherein the method has an adsorption capacity of about 600 to 700 mg/g at a pH of about 8.

5: The method of claim 1, wherein the adsorbent is a ZIF-8@MnCuAl-LTH, and wherein the ZIF-8@MnCuAl-LTH has a Brunauer-Emmett-Teller (BET) surface area of 40 to 50 square meters per gram (m²/g).

6: The method of claim 1, wherein the adsorbent is a ZIF-8@MnCuAl-LTH, and wherein the ZIF-8@MnCuAl-LTH has a cumulative pore volume of 0.2 to 0.25 cubic centimeters per gram (cm³/g).

7: The method of claim 1, wherein the adsorbent is a ZIF-8@MnCuAl-LTH, and wherein the ZIF-8@MnCuAl-LTH has an average pore diameter of 15 to 20θ nanometers (nm).

8: The method of claim 1, wherein the adsorbent is a MnCuAl-LTH@ZIF-8, and wherein the MnCuAl-LTH@ZIF-8 has a BET surface area of 630 to 650 m²/g.

9: The method of claim 1, wherein the adsorbent is a MnCuAl-LTH@ZIF-8, and wherein the MnCuAl-LTH@ZIF-8 has a cumulative pore volume of 0.1 to 0.15 cm³/g.

10: The method of claim 1, wherein the adsorbent is a MnCuAl-LTH@ZIF-8, and wherein the MnCuAl-LTH@ZIF-8 has an average pore diameter of 25 to 30 nm.

11: The method of claim 1, wherein the adsorbent is a MnCuAl-LTO@ZIF-8, and wherein the MnCuAl-LTO@ZIF-8 has a BET surface area of 480 to 500 m²/g.

12: The method of claim 1, wherein the adsorbent is a MnCuAl-LTO@ZIF-8, and wherein the MnCuAl-LTO@ZIF-8 has a cumulative pore volume of 0.05 to 0.1 cm³/g.

13: The method of claim 1, wherein the adsorbent is a MnCuAl-LTO@ZIF-8, and wherein the MnCuAl-LTO@ZIF-8 has an average pore diameter of 28 to 32 nm.

14: The method of claim 1, further comprising regenerating the adsorbent by:
separating the adsorbent containing the one or more anionic azo dyes after the contacting from the purified aqueous composition and washing with two or more aqueous liquids to form a regenerated adsorbent; and
wherein the regenerated adsorbent has a dye removal rate of at least 70% based on an initial concentration of the one or more anionic azo dyes present in the contaminated aqueous composition.

15: The method of claim 14, wherein the two or more aqueous liquids are selected from the group consisting of water, methanol, ethanol, propanol, butanol, pentanol, hexanol, and isomers and mixtures thereof.

16: The method of claim 1, wherein the adsorbent is a ZIF-8@MnCuAl-LTH, and wherein the method further comprises preparing the ZIF-8@MnCuAl-LTH by:
dispersing zeolitic imidazolate framework-8 (ZIF-8) in the form of particles in an alkaline solution to form a first dispersion;
mixing a manganese salt, a copper salt, and an aluminum salt in water to form an aqueous salt solution;
simultaneously dropwise adding and mixing the aqueous salt solution, and the alkaline solution to the first dispersion to form a reaction mixture; and
heating the reaction mixture at a temperature of 70 to 150 degrees Celsius (° C.).

17: The method of claim 16, wherein the alkaline solution comprises two or more inorganic salts selected from the group consisting of sodium carbonate, sodium bicarbonate, sodium hydroxide, potassium carbonate, potassium bicarbonate, and potassium hydroxide.

18: The method of claim 16, wherein a molar ratio of the manganese salt to the copper salt is in a range of 1:5 to 5:1, and wherein a molar ratio of the manganese salt to the aluminum salt is in a range of 1:5 to 5:1.

19: The method of claim 1, wherein the adsorbent is a MnCuAl-LTH@ZIF-8, and wherein the method further comprises preparing the MnCuAl-LTH@ZIF-8 by:
mixing a manganese salt, a copper salt, and an aluminum salt in water to form an aqueous salt solution;
mixing the aqueous salt solution and an alkaline solution to form a reaction mixture, heating, and drying to form a MnCuAl layered triple hydroxide modified zeolitic composite (MnCuAl-LTH) in the form of particles;
dispersing particles of the MnCuAl-LTH in water to form a dispersion;
mixing a zinc salt aqueous solution, an imidazole solution, and the dispersion thereby reacting to form the MnCuAl-LTH@ZIF-8.

20: The method of claim 19, further comprising preparing a MnCuAl layered triple oxide modified zeolitic composite (MnCuAl-LTO) by calcining the MnCuAl-LTH at a temperature of about 400 to 600° C.
